(19) United States
(12) Patent Application Publication
(10) Pub. No.: US 2016/0292805 A1
(43) Pub. Date: Oct. 6, 2016

(54) SHARING CONTENT UNDER UNIT-BASED LICENSING

(71) Applicant: Altair Engineering, Inc., Troy, MI (US)

(72) Inventors: James R. Scapa, West Bloomfield, MI (US); Stephanie Scapa, Royal Oak, MI (US)

(21) Appl. No.: 15/092,306

(22) Filed: Apr. 6, 2016

Related U.S. Application Data
(60) Provisional application No. 62/143,336, filed on Apr. 6, 2015.

(51) Int. Cl. G06Q 50/18

(52) U.S. Cl. CPC G06Q 50/184

(57) ABSTRACT

Sharing content under unit-based licensing may include receiving a content request from a device associated with a receiving user, the content request indicating content and a customer account, the content request generated in response to the device associated with the receiving user receiving a content communication from a sending user, the content communication indicating the content, identifying a cardinality of assigned units for the content, identifying a cardinality of available units for the customer account, determining, by a processor, whether the cardinality of assigned units is within the cardinality of available units, outputting a response indicating that the content request is granted on a condition that the cardinality of assigned units is within the cardinality of available units, and outputting a response indicating that the content request is denied on a condition that the cardinality of assigned units exceeds the cardinality of available units.

### CROSS-REFERENCE TO RELATED APPLICATIONS

This Application claims priority to U.S. Provisional Patent Application Ser. No. 62/143,336, filed Apr. 6, 2015, which is incorporated herein by reference in its entirety.

### TECHNICAL FIELD

The present disclosure relates to systems and methods of licensing access to digital content.

### BACKGROUND OF THE DISCLOSURE

Digital content such as computer software products, video games, music, and any other media capable of being embodied in digital format may be sold or licensed to an end user customer. For example, the right to copy, access, or execute the digital content may be licensed to a user and a provider or vendor may retain ownership of the rights to the content. Accordingly, it may be desirable to provide sharing content under unit-based licensing.

### SUMMARY OF THE DISCLOSURE

Disclosed herein are aspects, features, elements, implementations, and embodiments of sharing content under unit-based licensing.

In an embodiment, a method of sharing content under unit-based licensing is disclosed. Sharing content under unit-based licensing may include receiving a content request from a device associated with a receiving user, the content request indicating content and a customer account, the content request generated in response to the device associated with the receiving user receiving a content communication from a sending user, the content communication indicating the content. Sharing content under unit-based licensing may include identifying a cardinality of assigned units for the content, identifying a cardinality of available units for the customer account, and determining, by a processor, whether the cardinality of assigned units is within the cardinality of available units. Sharing content under unit-based licensing may include outputting a response indicating that the content request is granted on a condition that the cardinality of assigned units is within the cardinality of available units. Sharing content under unit-based licensing may include outputting a response indicating that the content request is denied on a condition that the cardinality of assigned units exceeds the cardinality of available units.

In another embodiment, a method of sharing content under unit-based licensing is disclosed. Sharing content under unit-based licensing may include identifying a content object, generating, by a processor of a device associated with a sending user in response to instructions stored on a non-transitory computer readable medium, a content communication indicating the content object, wherein the content object is associated with a cardinality of assigned units, and transmitting the content communication to a device associated with a receiving user, wherein the receiving user is associated with a customer account, wherein a cardinality of available units is associated with the customer account, such that the content object is accessible by the device associated with the receiving user on a condition that the cardinality of assigned units is within the cardinality of available units.

In another embodiment, a method of sharing content under unit-based licensing is disclosed. Sharing content under unit-based licensing may include receiving, at a device associated with a receiving user, a content communication from a device associated with a sending user, the content communication indicating content, in response to receiving the content communication, generating a content request indicating the content and a customer account associated with the receiving user, transmitting the content request to a platform device, on a condition that a cardinality of assigned units for the content is within a cardinality of available units for the customer account, receiving a response indicating that the content request is granted, on a condition that the cardinality of assigned units for the content exceeds the cardinality of available units for the customer account, receiving a response indicating that the content request is denied, and in response to receiving the response indicating that the content request is granted, accessing the content at the device associated with the receiving user.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The description herein makes reference to the accompanying drawings wherein like reference numerals refer to like parts throughout the several views, and wherein:

FIG. 1 is a diagram of an example of a communication system for sharing content under unit-based licensing in accordance with embodiments of this disclosure; and

FIG. 2 is a flow diagram of an example of unit-based licensing for digital content access in accordance with embodiments of this disclosure.

FIG. 3 is a diagram of an example of a portion of a user interface for content related communication in a unit-based licensing platform in accordance with embodiments of this disclosure;

FIG. 4 is a diagram of an example of a portion of a user interface including a content control detail portion for sharing content under unit-based licensing in accordance with embodiments of this disclosure;

FIG. 5 is a diagram of an example of a portion of a user interface including a sharing initiation control for sharing content under unit-based licensing in accordance with embodiments of this disclosure;

FIG. 6 is a diagram of an example of a portion of a user interface including a sharing communication type control for sharing content under unit-based licensing in accordance with embodiments of this disclosure;

FIG. 7 is a diagram of an example of a portion of a user interface including a sharing control portion for a sharing communication type for sharing content under unit-based licensing in accordance with embodiments of this disclosure;

FIG. 8 is a diagram of an example of a portion of a user interface including a sharing detail portion for a sharing communication type for sharing content under unit-based licensing in accordance with embodiments of this disclosure;

FIG. 9 is a diagram of an example of a portion of a user interface including another sharing detail portion for another sharing communication type for sharing content under unit-based licensing in accordance with embodiments of this disclosure;

FIG. 10 is a diagram of an example of a portion of a user interface including another sharing detail portion for another sharing communication type for sharing content under unit-based licensing in accordance with embodiments of this disclosure;

FIG. 11 is a diagram of an example of a portion of a user interface including a notifications portion for sharing content under unit-based licensing in accordance with embodiments of this disclosure;

FIG. 12 is a diagram of an example of a portion of a user interface including a recent activity portion for sharing content under unit-based licensing in accordance with embodiments of this disclosure; and

FIG. 13 is a diagram of an example of a portion of a user interface including a shared content portion for sharing content under unit-based licensing in accordance with embodiments of this disclosure.

### DETAILED DESCRIPTION

A creator or owner of content, such as digital content, may control access to the content by licensing the content to end users. For example, licensing may include controlling the right to access content, which may include controlling the right to display, perform, distribute, or reproduce the content. Unit-based licensing may include licensing that controls access to content by allocating licensing units to a customer account, such that one or more licensing units may be redeemed or charged to access one or more events or digital content objects. For example, in some embodiments, a content provider may redeem licensing units and provide content in response to a request for access by a customer. In some embodiments, a first customer, or sending customer, may communicate with a second customer, or receiving customer, regarding content. For example, a sending customer may share content with a receiving customer.

The aspects, features, elements, and embodiments of methods, procedures, or algorithms disclosed herein, or any part or parts thereof, may be implemented in a computer program, software, or firmware incorporated in a non-transitory computer-readable storage medium for execution by a computer or processor, such as a special purpose computer or processor, and may be implemented as a computer program product, such as a computer program product accessible from a tangible computer-usable or computer-readable medium.

As used herein, the terminology “computer” or “device” includes any unit, or combination of units, capable of performing any method, or any portion or portions thereof, disclosed herein. Devices may further include mobile devices that may include user equipment, a wireless transmit/receive unit, a mobile station, a fixed or mobile subscriber unit, a pager, a cellular telephone, a personal digital assistant (PDA), a computer, or any other type of user device capable of operating in a mobile environment.

As used herein, the terminology “processor” includes a single processor or multiple processors, such one or more special purpose processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any computer-usable or computer-readable medium or device that can, for example, tangibly contain, store, communicate, or transport any signal or information for use by or in connection with any processor. Examples of computer-readable storage mediums may include one or more read only memories, one or more random access memories, one or more registers, one or more cache memories, one or more semiconductor memory devices, one or more magnetic media, such as internal hard disks and removable disks, one or more magneto-optical media, one or more optical media such as CD-ROM disks, and digital versatile disks (DVDs), or any combination thereof.

As used herein, the terminology “example”, “embodiment”, “implementation”, “aspect”, “feature”, or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terminology “digital content” may include computer software programs, video games, music, movies, videos, or any other media that may be embodied in digital form, and which may be accessed, downloaded, input, or otherwise transferred to a computer or processor. Digital content may include digital data or digital files that may be processed by external application programs or may be executed by external software, hardware, or both. As used herein, the terminology “content” may include live content or fixed content. Fixed content may include any content that may be presented from a tangible storage medium, such as digital content. Live content may include any content that may be accessed substantially concurrently with the creation or generation of the content, such as the presentation of a movie in a movie theater, a concert, a sporting event, or any other live event.

As used herein, the terminology “event” may include any presentation, distribution, or display of content capable of concurrent, or nearly concurrent, access by multiple users. For example, an event may include a physical presentation, such a presentation at a movie theater, concert hall, park, venue, museum, or restaurant, or a virtual presentation, such as a broadcast over the Internet or a television broadcast.

As used herein, the terminology “access” or “accessing” may include presenting, downloading, executing, streaming, or otherwise interacting, or enabling interaction, with a digital content object or event. In some embodiments, digital content objects may be executed, stored, or both, at a provider location. In some embodiments, digital content objects may be stored locally on a customer network or customer device and the digital content objects may be executed or run on the customer network or device.

In some embodiments, a node based license may indicate that content is accessible by a unique device, such as a computer, a unique account, such as an account associated with an individual user, or a combination of a unique device and a unique account. In some embodiments, a network based license may indicate that content is accessible by one or more devices within a specified network. For example, a defined number of devices within the network may concurrently access the content. In some embodiments, a license, including a node based license or a network based license, may be associated with a unique content object or event, or with a suite of related content objects and events.

As used herein, the terminology “assigned units”, “price”, “licensing price” or variations thereof, may include an assigned number of licensing units that may be exchanged or redeemed to access a particular event or digital content object. As used herein, the terminology “licensed units” or “allocated units” may refer to a total number of units provided to a customer or customer group. As used herein, the terminology “checked out units”, “redeemed units”, or “exchanged units” may refer to assigned units charged to a customer for events or digital content being accessed. As used herein, the terminology “available units” may refer to a difference between licensed units and checked out units. In some embodiments, licensing units may be temporarily or permanently exchanged for access. Temporarily exchanged licensing units may be returned to the pool of available units associated with the customer upon termination or completion of content access. Returned units may be included in the available units allocated to the customer and may be redeemed for access to other events or digital content.

As used herein, the terminology “suballocated units” may refer to available units for a sending customer suballocated to a receiving customer. In some embodiments, suballocated units may be temporarily transferred from the available units for the sending customer to the available units for the receiving customer. In some embodiments, suballocated units may be suballocated for a defined temporal period, for a defined number, or cardinality, of available uses, or for a combination of a defined temporal period and a defined cardinality of available uses. In some embodiments, available suballocated units associated with a defined temporal period may be removed from the pool of available units associated with the receiving customer and a corresponding cardinality of available units may be returned to the pool of available units associated with the sending customer in response to the expiration of the associated temporal period. In some embodiments, the defined cardinality of available uses for suballocated units associated with a defined cardinality of available uses may be reduced, such as by one, upon termination or completion of content access by the receiving customer. In some embodiments, the defined cardinality of available uses for suballocated units associated with a defined cardinality of available uses may be reduced to zero upon termination or completion of content access by the receiving customer, the suballocated units may be removed from the pool of available units associated with the receiving customer, and a corresponding cardinality of available units may be returned to the pool of available units associated with the sending customer.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

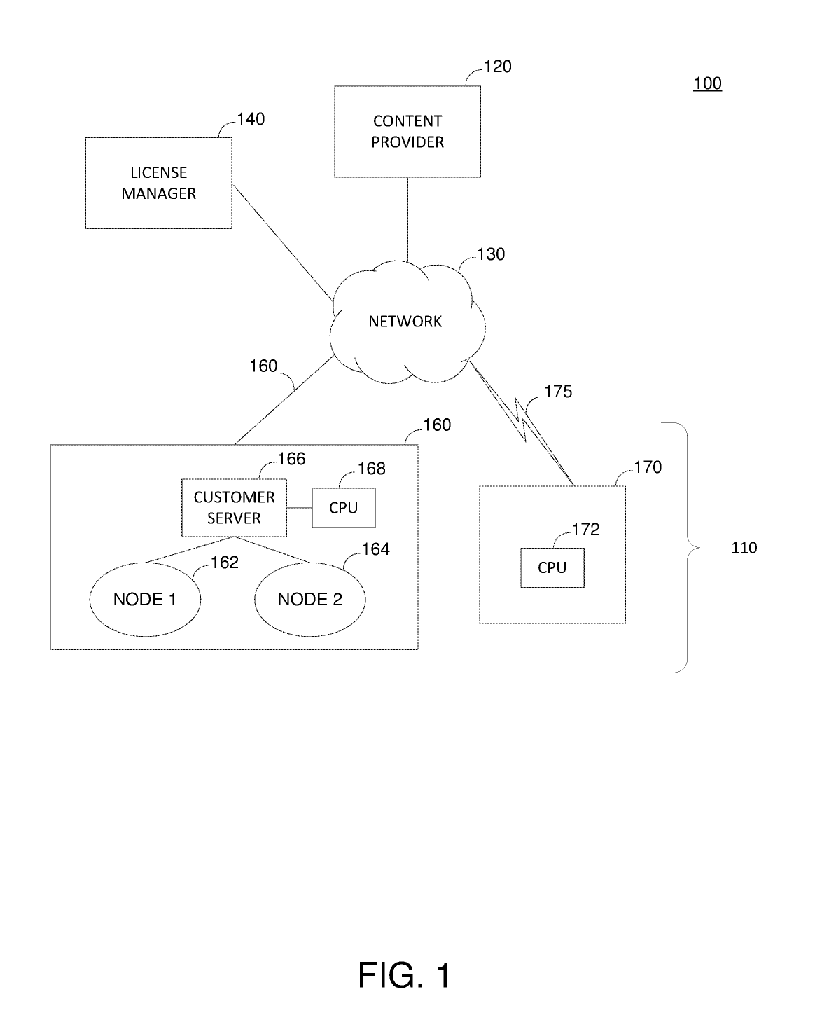

FIG. 1 is a diagram of an example of a communication system 100 for sharing content under unit-based licensing in accordance with embodiments of this disclosure. For simplicity, the communication system 100 shown in FIG. 1 includes a customer system 110, a provider 120, a network 130, and a license manager 140; however, other elements, such as multiple networks, access points, or communication mediums may be included in a communication system for sharing content under unit-based licensing.

In some embodiments, customer system 110 may be associated with an individual user or customer, and the user may access events or digital content using licensing units allocated to the user or to an account representing the user. In some embodiments, customer system 110 may comprise devices and networks through which a customer or user may access digital content from provider 120, or register for, or access, events. For example, as shown in FIG. 1, customer system 110 may include a customer network 160 and a customer device 170; however, any number of customer networks and customer devices may be used.

In some implementations, customer system 110 may be associated with a collection or group of customers, or members, and shared licensing units may be allocated to the group. For example, a group may include one or more families, a classroom of students, a small business, a social group, or any other organization capable of licensing events or digital content such that members of the group are capable of accessing the events or digital content.

In some embodiments, elements of the customer system 110, such as customer network 160 and customer device 170, may communicate with each other or with elements external to the customer system 110, such as the provider 120. For example, customer network 160 and customer device 170 may independently communicate through communication network 130.

In some embodiments, customer network 160 may include one or more individual nodes 162/164, a customer server 166, a host processor (CPU) 168, or any combination thereof. A node 162/164 may be a device, such as a computer, and may access digital content. For example, a node 162/164 may access digital content in response to user input. Although FIG. 1 includes a first node 162 and a second node 164 for simplicity, any number of nodes may be used. In some embodiments, a node 162/164 may be connected to a customer server 166 and may have a unique network address. In some embodiments, a node 162/164 may communicate with other nodes 162/164 within customer network 160. The customer server 166 may communicate with CPU 168. Although individual nodes 162/164 are depicted as being connected in a spoke configuration to the customer server 166, the individual nodes 162/164 may be connected in any other electronic computer network configuration. Although shown as separate units, in some embodiments, customer server 166 and CPU 168 may be combined into a single device.

In some embodiments, customer device 170 may be any device, such as a computer or mobile device, capable of accessing digital content. In some embodiments, a customer device 170 may include a processor, such as CPU 172.

In some embodiments, provider 120 may be a device or system configured to provide access to digital content to one or more licensed customers. For example, provider 120 may include an Internet Protocol (IP) network-based unit, such as a website service, that implements methods for controlling access to events or digital content. In some embodiments, provider 120 may provide customer system 110 access to digital content objects, which may be included in a suite of digital content. In some embodiments, provider 120 may be any system configured to control access to or registration for events by licensed customers. Although FIG. 1 shows the provider 120 as a single unit, the provider 120 may include any number of discrete units and any number of providers 120 may be used.

In some embodiments, the provider 120 may include an event provider (not shown separately) and may control access to or registration for one or more events. The event provider may be any system configured to receive a request to access or register for an event and output a response indicating whether access or registration is granted. In some embodiments, the request for access may include a request to register for the event, which may include receiving registration information. In some embodiments, the event provider may be the provider 120. In some embodiments, event provider may be separate from provider 120. Although shown as a single unit in FIG. 1, in some embodiments, the provider 120 may include a content provider as a first unit and the event provider as a second unit. For example, the content provider and the event provider may be independent units within a single physical device, or may be independent physical devices.

In some implementations, unit-based licensing for events and digital content may include communication between the customer system 110 and the provider 120 via the communication network 130. The communication network 130 may be a local area network (LAN), wide area network (WAN), virtual private network (VPN), a mobile or cellular telephone network, the Internet, or any other electronic communication medium. Although not explicitly shown in FIG. 1, each of the customer system 110, provider 120, and license manager 140 may communicate with communication network 130 through one or more Internet service providers (ISPs). In some embodiments, the customer network 160, the customer device 170, or both, may communicate with the network 130 via a wired connection 165 a wireless connection 175, or a combination of one or more wired or wireless connections.

In some embodiments, a license manager (LM) 140 may be included in the communication system 100. License manager 140 may control the access to events, digital content, or both, provided by provider 120. Although shown as a separate unit, in some embodiments, license manager 140 may be incorporated with provider 120, customer system 110, or both. In some embodiments, the license manager 140 may monitor content access for the customer system 110. For example, the license manager 140 may detect the termination or conclusion of access to content.

In some embodiments, license manager 140 may generate and maintain a log. The log may include a record of a number of available units that may be used by the customer system 110 at any given time. In some embodiments, the license manager 140 may update the log for each change of the available units for customer system 110. For example, the log may be updated to indicate a change in the available units in response to the accessing of events or digital content from provider 120, the termination of the access of events or digital content, or a change in pricing of events or digital content being accessed by the customer. In some embodiments, the log may be a file, or database, stored in a memory in communication with provider 120 or license manager 140.

Although not shown in FIG. 1, in some embodiments, communication system 100 may include a registration unit. In some embodiments, a registration unit may be a device, such as a computer. For example, the registration unit may be a kiosk physically located at an event location. In some embodiments, the registration unit may be configured to receive registration information. For example, the registration unit may include a user interface device, such as a keyboard or touchscreen, and may receive user input indicating registration information via the user input device. In some embodiments, the registration unit may communicate with a user device, such as customer device 170.

In some embodiments, sharing content under unit-based licensing may include controlling access to content in response to a request to access the event or digital content from a customer system.

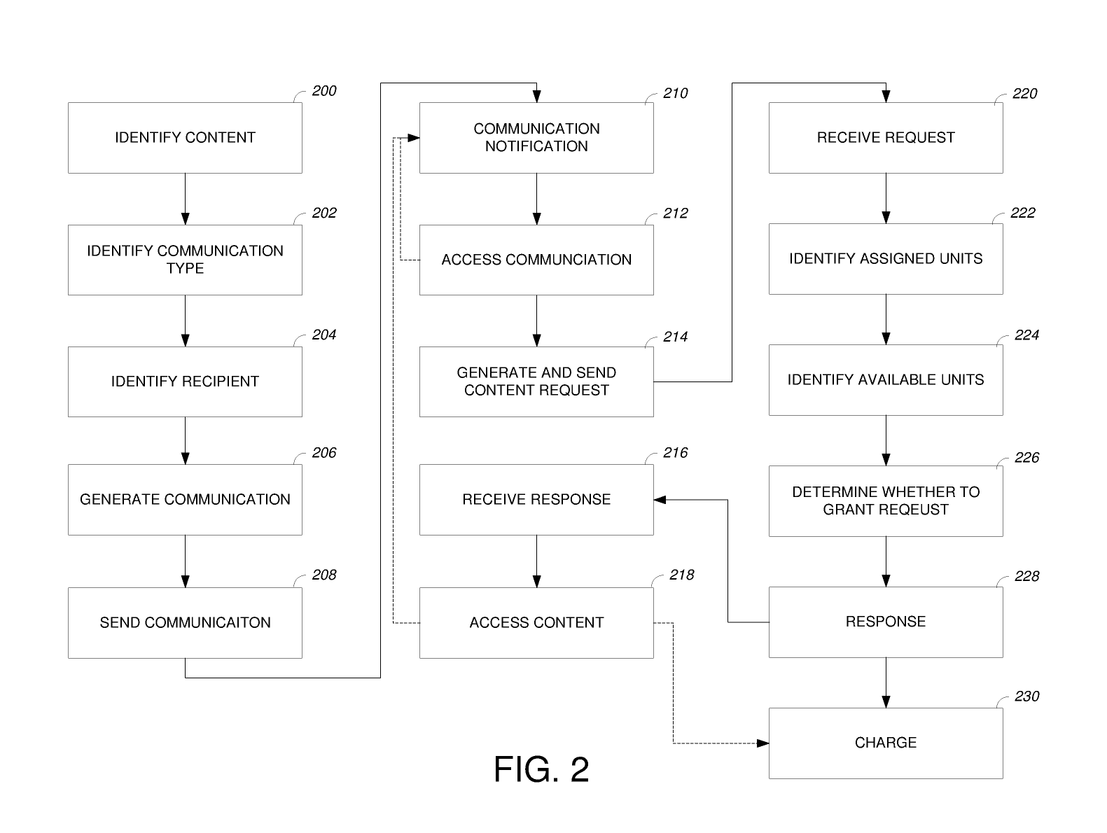

FIG. 2 is a flow diagram of an example of content related communication, such as content sharing, in a unit-based licensing platform in accordance with embodiments of this disclosure. Content related communication in a unit-based licensing platform may include temporarily or permanently exchanging licensing units for access to content. In some embodiments, sharing content under unit-based licensing may be implemented in a communication system, such as the communication system 100 shown in FIG. 1.

In some embodiments, content related communication in a unit-based licensing platform may include identifying content at 200, identifying a communication type at 202, identifying a recipient at 204, generating a communication at 206, sending the communication at 208, generating a communication notification at 210, accessing the communication at 212, generating and sending a content request at 214, receiving a response to the content request at 216, accessing the content at 218, receiving the content request at 220, identifying assigned units at 222, identifying available units at 224, determining whether to grant the request at 226, responding to the request at 228, charging for the content at 230, or a combination thereof.

Unit-based licensing may include licensing that controls access to content by allocating licensing units to a customer account, such that one or more licensing units may be redeemed or charged to access one or more events or digital content objects. In some embodiments, a customer account may be associated with an individual user or customer, or with a group of users associated with a customer account, and each user may access content using licensing units allocated to the user or to the customer account representing the user.

In some embodiments, one or more portions of content related communication in a unit-based licensing platform may be performed, at least in part, by a first instance of the unit-based licensing platform in response to input, such as user input, received from a first user, or sending user, associated with a first customer account. For example, identifying content at 200, identifying a communication type at 202, identifying a recipient at 204, generating a communication at 206, sending the communication at 208, or a combination thereof may be performed, at least in part, by the first instance of the unit-based licensing platform in response to input, such as user input, received from the first user associated with the first customer account.

In some embodiments, one or more portions of content related communication in a unit-based licensing platform may be performed, at least in part, by a second instance of the unit-based licensing platform in response to input, such as user input, received from a second user, or recipient, associated with the first customer account or with a second customer account. For example, receiving a communication notification at 210, accessing the communication at 212, generating and sending a content request at 214, receiving a response to the content request at 216, accessing the content at 218, or a combination thereof may be performed, at least in part, by the second instance of the unit-based licensing platform in response to input, such as user input, received from the recipient.

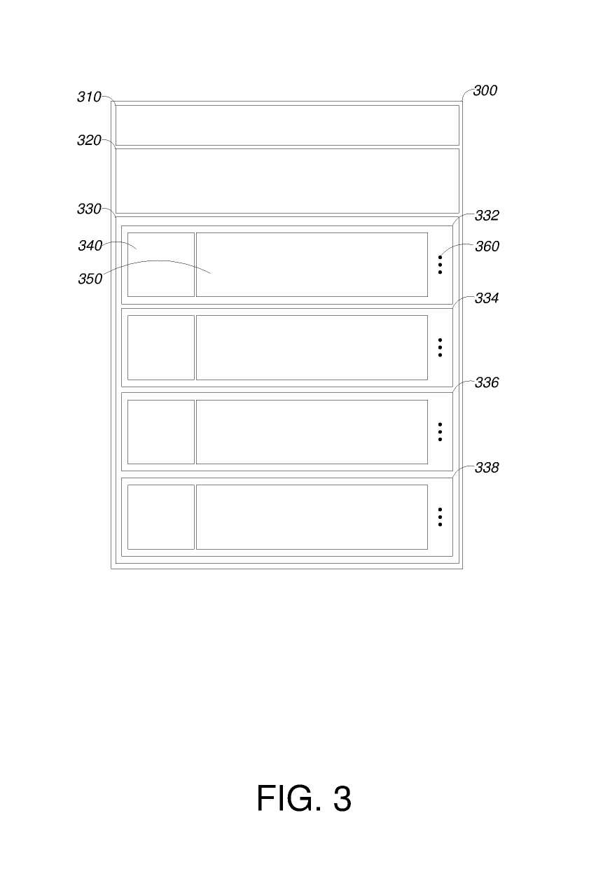

In some embodiments, content may be identified at 200. Identifying content at 200 may include identifying or selecting any type of content, such as an audio recording, an electronic text publication, a video, or a combination thereof. Although described in relation to music as an example herein, sharing content under unit-based licensing may be performed with any content, such as computer software programs, video games, music, movies, videos, or any other media that may be embodied in digital form, and which may be accessed, downloaded, input, or otherwise transferred to a computer or processor. In some embodiments, identifying content at 200 may include identifying a portion or portions of one or more content objects. For example, identifying content may include identifying a portion or portions of a song, a chapter of a book, or any other part or parts of the content. In some embodiments, identifying content at 200 may include identifying a collection or group of content, such as an album or a playlist. In some embodiments, content may be identified at 200 in response to input, such as user input, from a sending user via a user interface, or a portion thereof, of a first instance of the unit-based licensing platform. Examples of identifying content are shown in FIGS. 3-5.

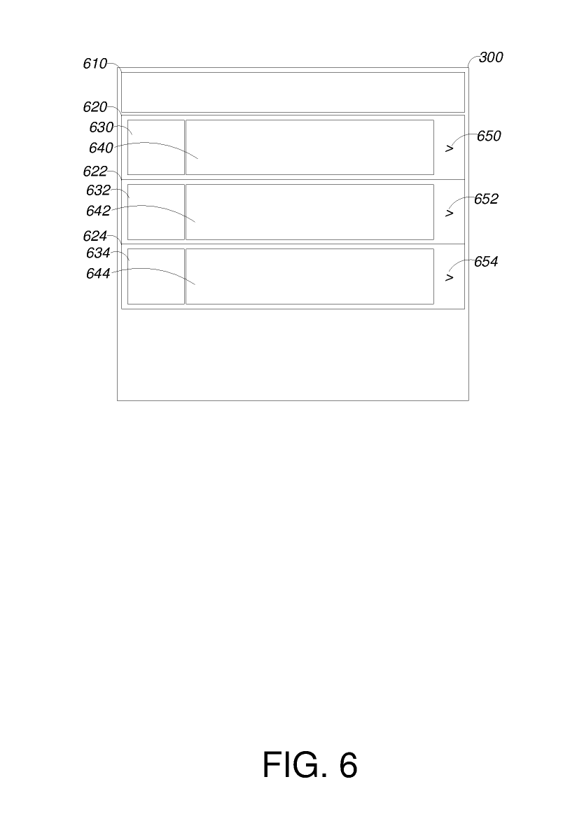

In some embodiments, a communication type may be identified at 202. Identifying a communication type at 202 may include selecting from one or more available communication types, such as platform communication, text message communication, or e-mail communication. In some embodiments, a communication type may be identified at 202 in response to input, such as user input, from the sending user via a user interface, or a portion thereof, of the first instance of the unit-based licensing platform. An example of identifying a communication type is shown in FIG. 6.

In some embodiments, one or more recipients may be identified at 204. Identifying one or more recipients at 204 may include determining whether to identify the recipients via a user interface, or a portion thereof, of the first instance of the unit-based licensing platform or via a user interface, or a portion thereof, of an external application, such as a third party text messaging system or a third party e-mail system. For example, whether to identify the recipients via a user interface, or a portion thereof, of the first instance of the unit-based licensing platform or via a user interface, or a portion thereof, of an external application, such as a third party text messaging system or a third party e-mail system may be determined based on the communication type identified at 202.

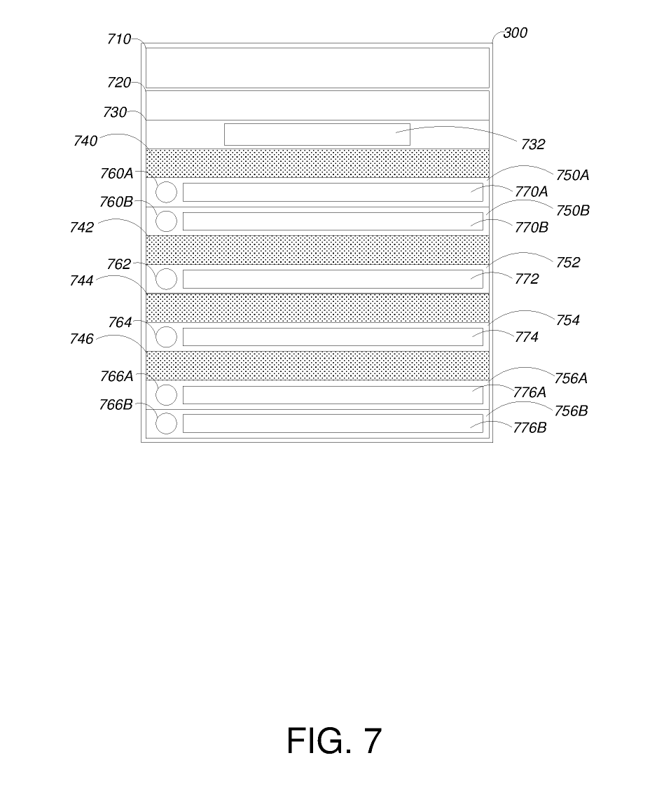

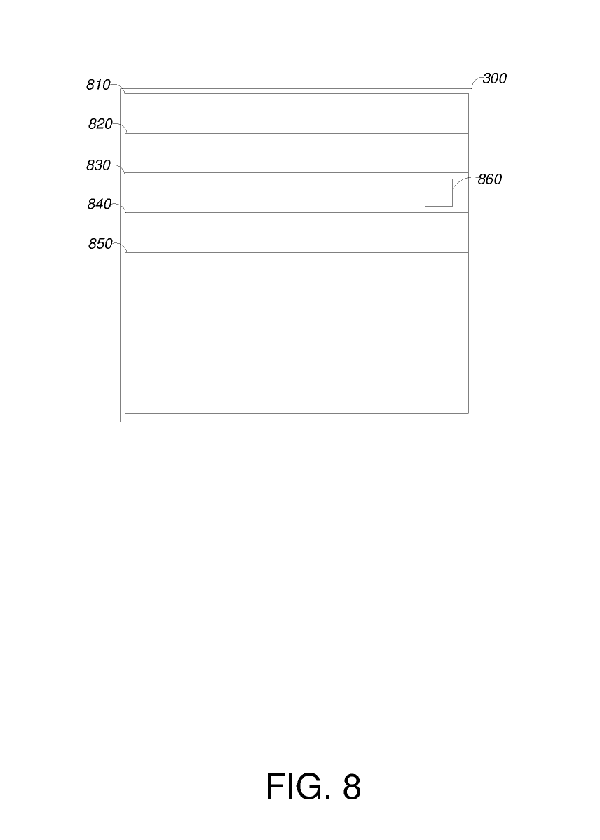

In some embodiments, one or more recipients may be identified at 204 in response to input, such as user input, from the sending user via a user interface, or a portion thereof, of the first instance of the unit-based licensing platform. An example of identifying one or more recipients via a user interface, or a portion thereof, of the first instance of the unit-based licensing platform is shown in FIGS. 7-8.

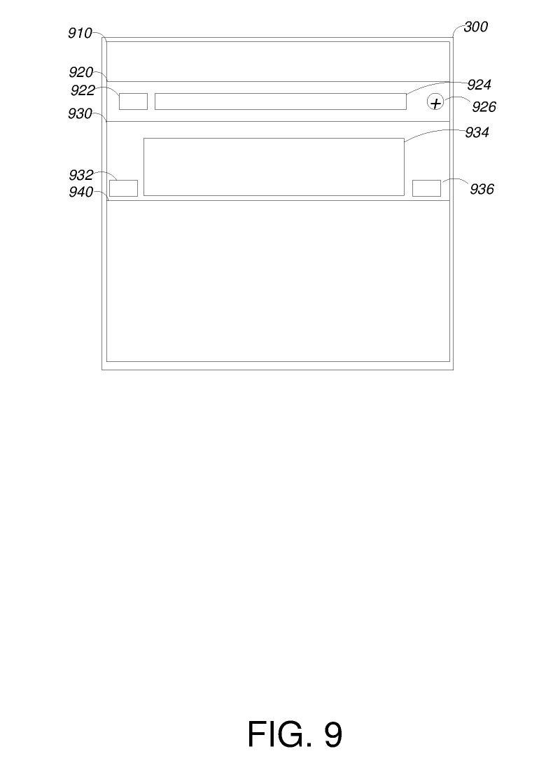

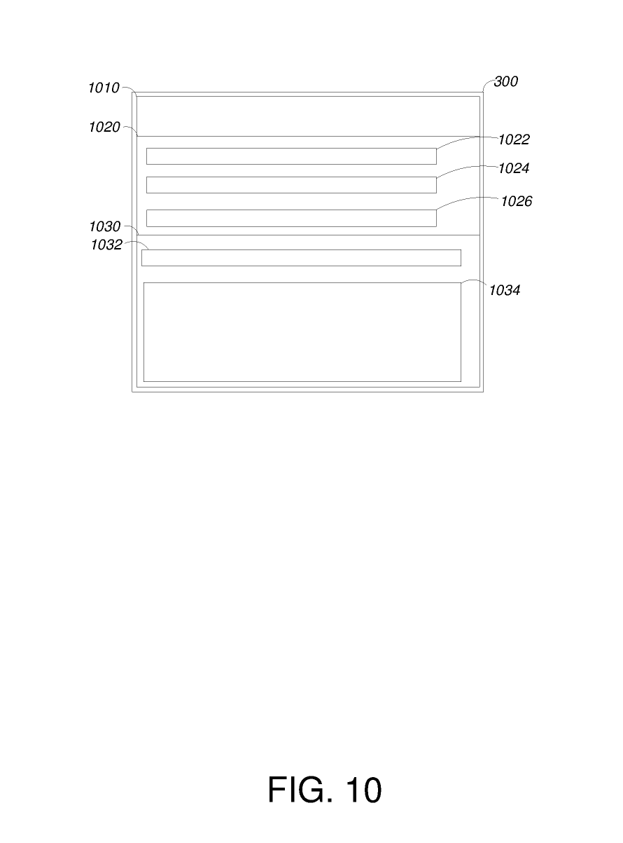

In some embodiments, one or more recipients may be identified at 204 in response to input, such as user input, from the sending user via a user interface, or a portion thereof, of an external application, such as a third party text messaging system or a third party e-mail system. An example of identifying one or more recipients via a user interface, or a portion thereof, of an external application, such as a third party text messaging system or a third party e-mail system, is shown in FIGS. 9-10.

In some embodiments, a communication may be generated at 206. Generating a communication at 206 may include generating a subject or title for the communication, generating text for the communication, determining a representation of the content selected at 200, or a combination thereof.

Generating a communication at 206 may be based on the communication type identified at 202. For example, the communication type identified at 202 may be platform communication, and generating the communication at 206 may include identifying content information, a content representation, or both, as shown in FIG. 8. The content information may include a name or description of the content, such as a song title, a name or description of a content group that includes the content, such as an album name, a name or description of one or more authors of the content, such as an artist name, or a combination thereof. The content representation may include a graphical representation of the content, such as a default content representation, which may be content type specific, or a content specific representation, such as album art. In some embodiments, the content information, the content representation, or both, may be automatically generated. For example, the content information, the content representation, or both, may be generated automatically based on the identified content. In some embodiments, the content information, the content representation, or both, may be user generated. For example, the content information, the content representation, or both, may be identified in response to input, such as user input. For example, a user may select or upload an image for use as a content representation.

In another example, the communication type identified at 202 may be text message communication, and generating the communication at 206 may include automatically generating a text message, as shown in FIG. 9.

In another example, the communication type identified at 202 may be e-mail message communication, and generating the communication at 206 may include identifying content information, a content representation, or both, automatically generating an e-mail message, as shown in FIG. 10. For example, generating the e-mail message may include automatically incorporating the content information, such as a song title and artist name, and content representation in the e-mail message.

In some embodiments, a communication may be sent at 208. For example, the communication type identified at 202 may be platform communication, and the communication may be sent, at least in part, via, a customer system, such as the customer system 160 shown in FIG. 1. Sending a communication using platform communication may include sending the communication via an external system or network, such as the internet, which may include sending the communication via a platform device, which may be a unit-based licensing platform control device, such as the license manager 140 or the content provider 120 shown in FIG. 1. In another example, the communication type identified at 202 may be text message communication or e-mail communication and sending the communication at 208 may include sending the communication via an external system or network, such as the internet. Sending a communication using text message communication or e-mail communication may include sending the communication, at least in part, via, a customer system, such as the customer system 160 shown in FIG. 1. In some embodiments, sending the communication using text message communication or e-mail communication may include sending an indication of the communication to a platform device.

In some embodiments, sending the communication at 208 may include sending the communication from a sending user to a receiving user and may include suballocating available licensing units allocated to a customer system associated with the sending user with a customer system associated with the receiving user. In some embodiments, suballocated units may be temporarily removed from the available units for the sending customer and added to the available units associated with the receiving customer for accessing the content indicated in the communication in response to sending the communication at 208. In some embodiments, removing the suballocated units from the available units for the sending customer may be omitted, and the suballlocated units may be available for accessing, by the sending customer, any content accessible by the sending customer, or for accessing the content indicated in the communication by the receiving customer.

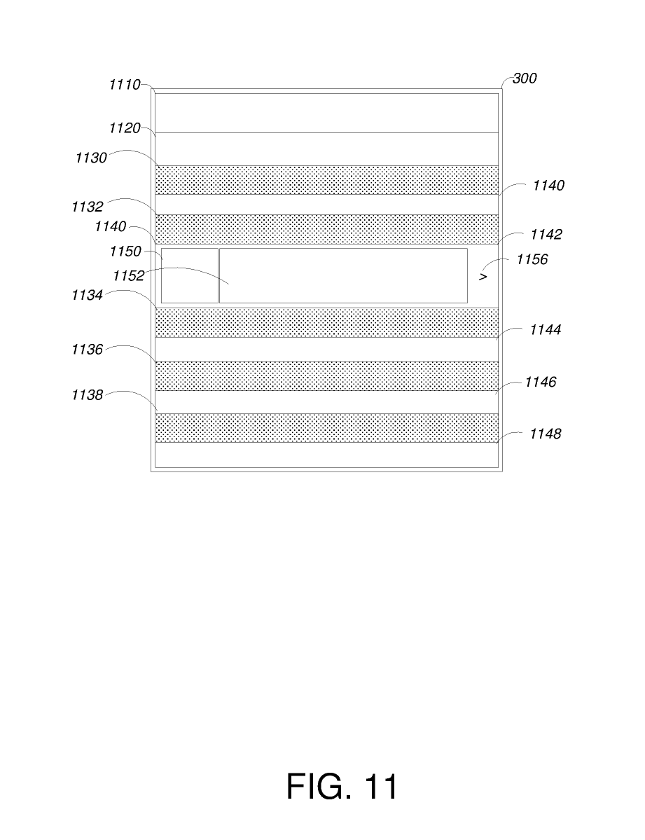

A communication notification may be generated at 210. For example, the communication type identified at 202 may be platform communication, the communication may be sent, at least in part, via, a customer system, such as the customer system 160 shown in FIG. 1, the communication may be received by the second instance of the unit-based licensing platform, which may be on a device, such as customer device 170 shown in FIG. 1, and the second instance of the unit-based licensing platform may generate the communication notification for presentation to the receiving user at the device, as shown in FIG. 11. In another example, the communication type identified at 202 may be text message communication or e-mail communication, the communication may be sent at 208 via an external system or network, such as the internet, the communication may be received by a device, such as customer device 170 shown in FIG. 1, and the device may generate the communication notification for presentation to the receiving user at the device.

In some embodiments, a communication notification may be generated and presented to the sending user by the first instance of the unit-based licensing platform. For example, the second instance of the unit-based licensing platform may generate and send a message, such as a read receipt, to the first instance of the unit-based licensing platform in response to the receiving user accessing the communication at 212 or accessing the content at 218 (shown using broken lines in FIG. 2), and the first instance of the unit-based licensing platform may generate and present a communication notification to the sending user in response to receiving the message from the second instance of the unit-based licensing platform, as shown in FIG. 11.

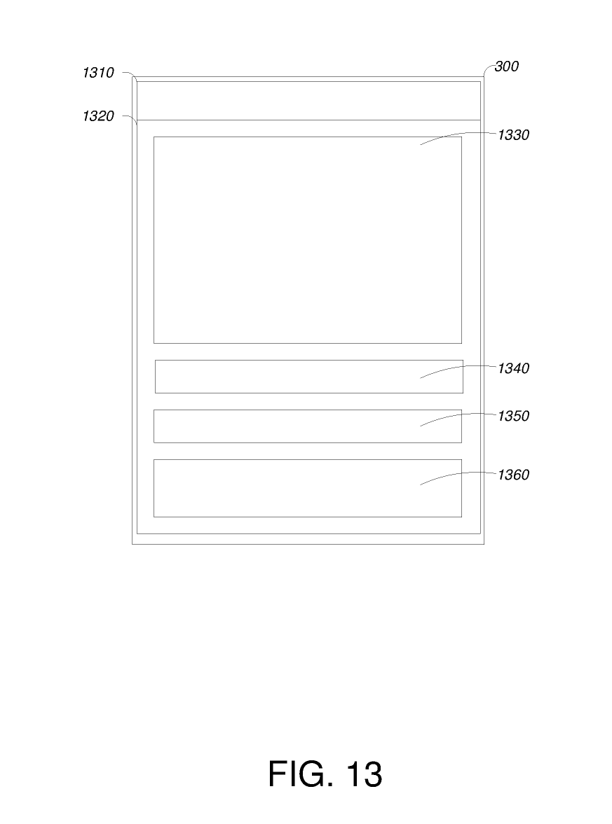

In some embodiments, the communication may be accessed at 212. For example, the communication type identified at 202 may be platform communication and the communication may be accessed via a user interface portion of the second instance of the unit-based licensing platform, as shown in FIG. 13. In another example, the communication type identified at 202 may be text message communication or e-mail communication, and the communication may be accessed by the receiving user via an external text messaging or e-mail system.

A request to access content may be generated and sent at 214. For example, the content request may be generated by the second instance of the unit-based licensing platform in response to input, such as user input from the receiving user selecting, which may include selecting a play control, such as the play control 1350 shown in FIG. 13. The content request may be sent to unit-based licensing platform control device, such as the license manager 140 or the content provider 120 shown in FIG. 1.

In some embodiments, the request to access content may be received at 220. For example, a provider, such as the provider 120 shown in FIG. 1, may receive the request from a customer, such as the customer system 110 shown in FIG. 1. In some embodiments, the request may indicate a selected digital content object, such as the content identified at 200. In some embodiments, the request to access content may include information identifying the receiving user, a customer account associated with the receiving user, the sending user, a customer account associated with the sending user, or a combination thereof.

In some embodiments, assigned license units for the selected content may be identified at 222. In some embodiments, the number of assigned units for the content may remain constant or may vary over time. In some embodiments, a license manager, such as the license manager 140 shown in FIG. 1, may identify the assigned license units for the selected content. In some embodiments, the license manager may be independent of the provider, and the license manager may receive the request from the customer system via the network or via the provider. In some embodiments, determining the assigned license units for the selected content may be based on the receiving user, a customer account associated with the receiving user, the sending user, a customer account associated with the sending user, or a combination thereof.

In some embodiments, a number or cardinality of available units associated with the receiving user, or a customer account associated with the receiving user, may be determined at 224. In some embodiments, the available units may indicate a number of licensing units that may be used by the customer system associated with the receiving user at a given time, such as at the time the request is received. For example, although not shown in FIG. 2, one or more licensing units may be allocated or licensed to the customer system associated with the receiving user, one or more of the allocated units may be temporarily or permanently exchanged or checked out for access to content, and the number of available units may indicate the difference between the number of allocated units and the number of checked out units. In some embodiments, the available units may indicate a number of licensing units that may be used by the customer system associated with the sending user at a given time, such as at the time the request is received. In some embodiments, the available units may indicate a number of licensing units that may be used by the customer system associated with the sending user and the receiving user at a given time, such as at the time the request is received.

In some embodiments, the cardinality of available units may include suballocated units. For example, the cardinality of available units may include suballocated units suballocated from the sending customer to the receiving customer in response to sending the communication at 208. In some embodiments, a temporal period associated with suballocated units may be expired and the suballocated units may be omitted from the available units. In some embodiments, a cardinality of available uses for the suballocated units may be zero and the suballocated units may be omitted from the available units.

In some embodiments, whether to grant access may be determined at 226. For example, determining whether to grant access at 226 may be based on the count of available units identified at 224, the number of assigned units for the content identified at 222, or a combination thereof. For example, determining whether to grant access at 240 may include determining whether the count of available units is equal to or greater than the number of assigned units for the content.

In some embodiments, determining whether to grant access at 226 may include determining the number of available licensing units allocated to the customer system associated with the receiving user to charge against the customer system associated with the receiving user for access to the selected content. In some embodiments, the provider or the licensing manager may determine the number of checked out units currently charged against the customer system associated with the receiving user, and may determine a number of licensing units to charge against the customer system associated with the receiving user based on a difference between the number of assigned units for the requested content and the number of currently checked out units for the customer system associated with the receiving user. For example, the number of currently checked out units for the customer system associated with the receiving user may be greater than the number of assigned units, the request may be granted and the number of units to charge against the customer system associated with the receiving user may be zero. In another example, the number of currently checked out units for the customer system associated with the receiving user may be less than the number of assigned units, the request may be granted, and the number of units to charge against the customer system associated with the receiving user may be equal to the difference between the number of assigned units and the number of currently checked out units.

In some embodiments, a response may be output at 228. For example, the provider or licensing manager may generate a response indicating that the request for access is granted or denied and may transmit the response to the customer system associated with the receiving user. In some embodiments, the request for access may be denied. For example, the number of available units associated with the customer may be less than the number of assigned units for the requested content and the request may be denied. In some embodiments, the provider may reject the request and may prevent the customer system from accessing to the content. In some embodiments, the request for access may be granted. For example, the number of available units associated with the customer may be equal to or greater than the number of assigned units for the requested content and the request may be granted.

In some embodiments, available units, such as the available units identified at 224, may be charged at 230 based on a cardinality of assigned units, such as the assigned units identified at 222. In some embodiments, the available units may be charged in response to granting the request for access. In some embodiments, the available units may be charged in response to receiving the content at the customer system from the provider. In some embodiments, the available units may be charged in response to accessing the content by one or more customer devices or nodes in the customer system at 218.

In some embodiments, charging the available units may include recording the number of licensing units charged, updating the number available units, or both. In some embodiments, the license manager or provider may record any change in charged units or available units in a log. In some embodiments, the number of available units may be decreased in an amount equal to the number of assigned units for the content indicated in the request.

In some embodiments, charging the available units at 230 may include receiving information indicating that a customer device or node is accessing the requested content (shown using a broken line in FIG. 2). For example, the content may be accessed from the provider in response to receiving the response generated at 228.

In some embodiments, the available units may include suballocated units and charging the available units at 230 may include charging the suballocated units. In some embodiments, sending the communication at 208 may omit reducing the cardinality of available units for the sending customer by the cardinality of suballocated units and charging the available units at 230 may include reducing the reducing the cardinality of available units for the sending customer.

In some embodiments, the second instance of the unit-based licensing platform may receive at 216 a response to the request sent at 214, which may be the response generated at 228, and may access the content at 218.

FIG. 3 is a diagram of an example of a portion of a user interface 300 for content related communication, such as sharing content, in a unit-based licensing platform in accordance with embodiments of this disclosure. In some embodiments, content related communication in a unit-based licensing platform may include using a user interface of the unit-based licensing platform. In some embodiments, a user interface, or a portion thereof, 300 for content related communication in a unit-based licensing platform may include one or more portions, such as a first portion 310, a second portion 320, a third portion 330, or a combination thereof as shown.

The first portion 310, or header portion, may include primary information or controls, such as icons or links to user interface functions (not shown), which may include a menu icon, one or more media type icons, a search icon, or a combination thereof. Although the first portion 310 is described as including primary information or controls, any information or controls may be included in the primary portion 310.

The second portion 320 may include secondary information or controls, such as icons or links to contextual user interface functions (not shown). For example, a music media type icon may be selected from the first portion 310 and the second portion 320 may include information, controls, or both, related to music, such as a playlist link, a songs link, an albums link, or any other information or control related to the context of the second portion 320. Although the second portion 320 is described as including secondary information or controls, which may include controls related to a context identified by a primary control, any information or controls may be included in the second portion 320.

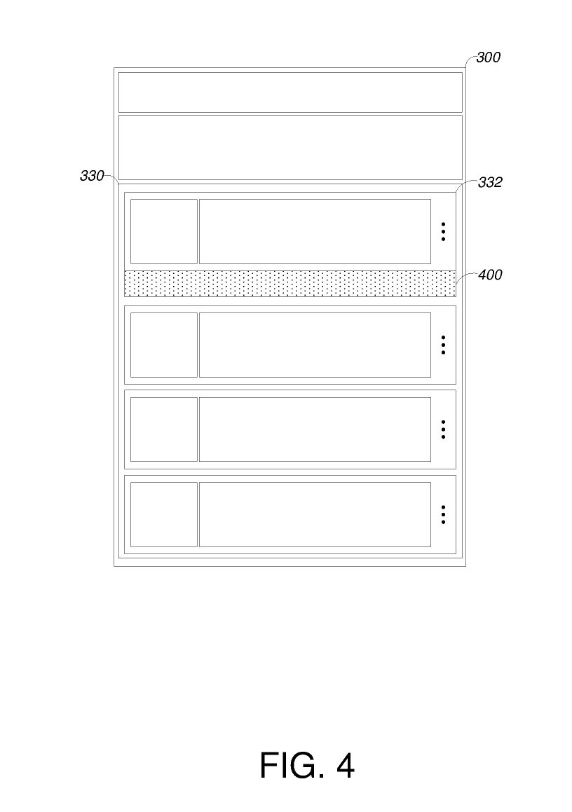

The third portion 330 may include tertiary information or controls, such as a content listing. For example, an instance of the user interface 300 may be instantiated in association with a customer account, the customer account may be associated with content, such as multiple songs, a songs link may be selected from the second control portion 320, and the third control portion 330 may include a list including a respective song container 332/334/336/338 for each of one or more of the songs. In some embodiments, a song container 332/334/336/338 may include a content representation portion 340, a content information portion 350, a content control portion 360, or a combination thereof. For example, the content representation portion 340 may include album or track art for the content, the content information portion 350 may include a track title, album title, and author information for the content, and the content control portion 360 may include a link to a content control detail portion as shown in FIG.4. Although the third portion 330 is described as including tertiary information or controls, which may include controls related to a context identified by a secondary control, any information or controls may be included in the third portion 330.

In some embodiments, including the content listing in the third control portion 330 may include identifying content. For example, an instance of the user interface 300 may be associated with a customer account, and including the content listing in the third control portion 330 may include identifying content associated with the customer account, or based on any other content identification, filtering, or sorting metric, or combination of metrics.

FIG. 4 is a diagram of an example of a portion of a user interface 300 including a content control detail portion 400 for sharing content under unit-based licensing in accordance with embodiments of this disclosure. In some embodiments, sharing content under unit-based licensing may include using a content control detail portion 400. The portion of the user interface 300 shown in FIG. 4 may be similar to the portion of the user interface 300 shown in FIG. 3, except as described herein.

In some embodiments, the content control detail portion 400 may be included in the user interface 300 in response to selecting a link in the content control portion 360 for content represented by a content container 332. The content control detail portion 400 may include, for example, information or controls (not shown), such as one or more icons, links, or other controls, associated with the content, such as a favorite setting, a download link, a share control, or any other control for the content. Although the content control detail portion 400 is described as including information or controls related to the corresponding content, any information or controls may be included in the content control detail portion 400. In some embodiments, the content control detail portion 400 may be visually differentiated for presentation or display by, for example, including a content control detail portion specific background color. In FIG. 4, the content control detail portion 400 is shown with a stippled background to indicate a visual differentiation.

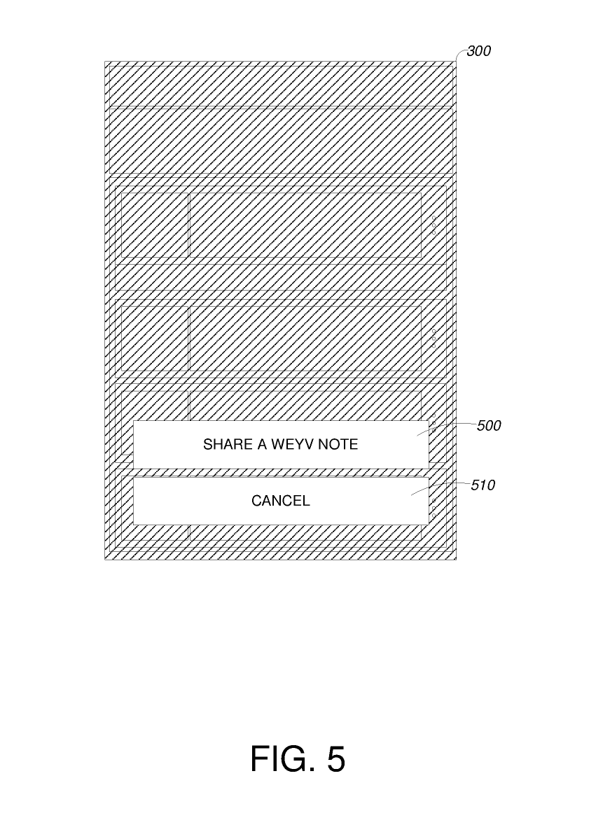

FIG. 5 is a diagram of an example of a portion of a user interface 300 including a sharing initiation control for sharing content under unit-based licensing in accordance with embodiments of this disclosure. In some embodiments, a sharing initiation control may include a confirm portion 500, a cancel portion 510, or both. In some embodiments, the sharing initiation control may include one or more other portions (not shown), such as a gift portion.

In some embodiments, the sharing initiation control may be included in the user interface 300 in response to input, such as user input. For example, the sharing initiation control may be included in the user interface 300 in response to receiving input selecting the share control from the content control detail portion 400 for the content as shown in FIG. 4. In another example, the sharing initiation control may be included in the user interface 300 in response to receiving input selecting, or pressing on, the content for a period greater than a content selection threshold, which may be referred to as long pressing the content.

In some embodiments, including the sharing initiation control in the user interface 300 may include determining whether the content is available to share. In some embodiments, the sharing initiation control may be included in the user interface 300 in response to determining that the content is available to share. Although not shown in FIG. 5, in some embodiments the content may be unavailable to share, the sharing initiation control may be omitted, and a message indicating that the content is not available to share may be included in the user interface 300.

In some embodiments, the user interface 300, or a portion thereof, may be visually differentiated or deemphasized in response to receiving input selecting the share control. For example, one or more portions of the user interface 300 may be displayed using an alternative visual style, such as a grayed out style. In FIG. 5, portions of the user interface 300 are shown using diagonal lines to indicate that the portions are not currently in focus, which may indicate that the portions are inactive.

FIG. 6 is a diagram of an example of a portion of a user interface 300 including a sharing communication type control for sharing content under unit-based licensing in accordance with embodiments of this disclosure. In some embodiments, a sharing communication type control may include a sharing communication type header portion 610, one or more sharing communication type control portions 620/622/624, or a combination thereof.

In some embodiments, the sharing communication type control may be included in the user interface 300 in response to input, such as user input. For example, the sharing communication type control may be included in the user interface 300 in response to receiving input selecting the confirm portion 500 shown in FIG. 5.

The sharing communication type header portion 610 may include context information or controls, such as icons or links to user interface functions (not shown), which may include a back icon, information describing the context, such as “WEYV NOTES”, or a combination thereof. Although the sharing communication type header portion 610 is described as including context information or controls, any information or controls may be included in the sharing communication type control portion 610.

Each sharing communication type control portion 620/622/624 may include sharing communication type information or controls. For example, each sharing communication type control portion 620/622/624 may include a sharing communication type representation portion 630/632/634, a sharing communication type information portion 640/642/644, a sharing communication type control portion 650/652/654, or a combination thereof. For example, the sharing communication type representation portion 630/632/634 may include an icon representing the sharing communication type, the sharing communication type information portion 640/642/644 may include a name or description for the sharing communication type, and the sharing communication type control portion 650/652/654 may include a link to a sharing control portion for the respective sharing communication type as shown in FIG. 7.

For example, the first sharing communication type control portion 620 may represent a first sharing communication type, such as platform sharing, the first sharing communication type representation portion 630 may include an icon representing the first sharing communication type, the first sharing communication type information portion 640 may include a name of the first sharing communication type, such as “WEYV”, and the first sharing communication type control portion 650, may include a link to a sharing control portion for the first sharing communication type, such as a platform sharing control portion.

The second sharing communication type control portion 622 may represent a second sharing communication type, such as text message sharing, the second sharing communication type representation portion 632 may include an icon representing the second sharing communication type, the second sharing communication type information portion 642 may include a name of the second sharing communication type, such as “Text”, and the second sharing communication type control portion 652, may include a link to a sharing control portion for the second sharing communication type, such as a text sharing control portion.

The third sharing communication type control portion 624 may represent a third sharing communication type, such as e-mail sharing, the third sharing communication type representation portion 634 may include an icon representing the third sharing communication type, the third sharing communication type information portion 644 may include a name of the third sharing communication type, such as “E-Mail”, and the third sharing communication type control portion 654, may include a link to a sharing control portion for the third sharing communication type, such as an e-mail sharing control portion.

In some embodiments, one or more other sharing communication types may be included, such as social media sharing communication types, one or more of the sharing communication types described can be omitted, or a combination thereof.

FIG. 7 is a diagram of an example of a portion of a user interface 300 including a sharing control portion for a sharing communication type, such as the platform sharing type 620 shown in FIG. 6, for sharing content under unit-based licensing in accordance with embodiments of this disclosure. In some embodiments, a sharing control portion may include a sharing control header portion 710, a current contact search context portion 720, a search input portion 730, one or more contact group portions 740/742/744/746, one or more contact portions 750A/750B/752/754/756A/756B, or a combination thereof.

In some embodiments, the sharing control portion may be included in the user interface 300 in response to input, such as user input. For example, the sharing control portion may be included in the user interface 300 in response to receiving input selecting a sharing communication type, such as the platform sharing type 620 as shown in FIG. 6.

The sharing control header portion 710 may include context information or controls, such as icons or links to user interface functions (not shown), which may include a back icon or a next link, information describing the context, such as “WEYV USERS”, or a combination thereof. Although the sharing control header portion 710 is described as including context information or controls, any information or controls may be included in the sharing control header portion 710.

The current contact search context portion 720 may include information indicating a current search context, such as a default search context or a previously searched context. The search input portion 730 may include a search input field or control 732, which may accept input, such as user input. For example, the search input portion 730 may accept user input indicating a search parameter, such as a contact name. In some embodiments, sharing content under unit-based licensing may include searching an information source, such as a database, for contact information based on a search parameter in response to input, such as user input, and generating one or more contact group portions, which may include one or more contact portions, which may represent one or more contacts or people associated with the customer account, or with an identified user associated with the customer account, based on a result of the search.

Each of the contact group portions 740/742/744/746 may include information, such as a name or a description, of a contact group, contact type, or other contact metric. For example, the first contact group portion 740 may include information indicating that the contact group is associated with one or more most recently interacting contacts, the second contact group portion 742 may include information indicating that the contact group is associated with one or more contacts included in an expressly defined group, the third contact group portion 744 may include information indicating that the contact group is associated with one or more contacts that are following the customer account, or with an identified user associated with the customer account, and the fourth contact group portion 746 may include information indicating that the contact group is associated with one or more contacts that the customer account, or an identified user associated with the customer account, is following. In some embodiments, the contact group portions 740/742/744/746 may be visually differentiated for presentation or display by, for example, including a contact group portion specific background color. In FIG. 7, the contact group portions 740/742/744/746 are shown with a stippled background to indicate a visual differentiation.

Each of the contact portions 750A/750B/752/754/756A/756B may include may include respective contact information. For example, each of the contact portions 750A/750B/752/754/756A/756B may include a contact representation portion 760A/760B/762/764/766A/766B, such as an icon, a contact name or description 770A/77B/772/774/776A/776B, or a combination thereof.

FIG. 8 is a diagram of an example of a portion of a user interface 300 including a sharing detail portion for a sharing communication type for sharing content under unit-based licensing in accordance with embodiments of this disclosure. In some embodiments, a sharing detail portion may include a sharing detail header portion 810, a selected content information portion 820, a selected content representation portion 830, a selected contact portion 840, a sharing message portion 850, or a combination thereof.

In some embodiments, the sharing detail portion may be included in the user interface 300 in response to input, such as user input. For example, the sharing detail portion may be included in the user interface 300 in response to receiving input selecting one or more contacts as shown in FIG. 7.

The sharing detail header portion 810 may include context information or controls, such as icons or links to user interface functions (not shown), which may include a back icon or a send link, information describing the context, such as “WEYV NOTES”, or a combination thereof. Although the sharing detail header portion 810 is described as including context information or controls, any information or controls may be included in the sharing detail header portion 810.

The selected content information portion 820 may include a content name or description information, content author information, or other content information, such as an album or collection name, for the content, which may be content selected as shown in FIG. 3.

The selected content representation portion 830 may include album or track art for the content 860. Although not shown in FIG. 8, the selected content representation portion 830 may include a control or link to add, edit, or delete the album or track art for the content 860. For example, the selected content representation portion 830 may include a ‘Upload New Image’ link, and an upload image control (not shown) may be included in the user interface 300 in response to receiving input, such as user input, selecting the ‘Upload New Image’ link.

The selected contact portion 840 may include descriptive information, such as “Send to”, and a name or description of one or more selected contacts, such as contacts selected as shown in FIG. 7.

The sharing message portion 850 may include placeholder information, such as “Add your own, personal message here.” The sharing message portion 850 may accept input, such as user input. For example, the sharing message portion 850 may accept user input, such as text. In some embodiments, the sharing message portion 850 may include default information or previously received input information.

FIG. 9 is a diagram of an example of a portion of a user interface 300 including another sharing detail portion for another sharing communication type, such as the text sharing type 632 shown in FIG. 6, for sharing content under unit-based licensing in accordance with embodiments of this disclosure. In some embodiments, a sharing detail portion may include a sharing detail header portion 910, a recipient portion 920, a sharing message portion 930, an input control portion 940, such as a virtual keyboard, or a combination thereof. In some embodiments, the sharing detail portion may be part of an external application, such as a third party texting application.

In some embodiments, the sharing detail portion may be included in the user interface 300 in response to input, such as user input. For example, the sharing detail portion may be included in the user interface 300 in response to receiving input selecting a sharing communication type, such as the text sharing type 632 shown in FIG. 6.

The sharing detail header portion 910 may include context information or controls, such as icons or links to user interface functions (not shown), which may include a cancel link, information describing the context, such as “New Message”, or a combination thereof. Although the sharing detail header portion 910 is described as including context information or controls, any information or controls may be included in the sharing detail header portion 910.

The recipient portion 920 may include descriptive information 922, such as “To:”, a name or description of one or more selected contacts 924, a control 926, such as an add recipient control, or a combination thereof.

The sharing message portion 930 may include a first control portion 932, such as an attach content control, a message text portion 934, a second control portion 936, such as a send control, or a combination thereof. The message text portion 934 may include automatically generated text, such as text indicating that the customer account, or a user associated with the customer account, has sent a platform note, such as a “WEYV NOTE”. The automatically generated text may include instructions for accessing the platform note, which may include a link, such as a hyperlink, to access, download, or install an application, or a portion thereof.

FIG. 10 is a diagram of an example of a portion of a user interface 300 including another sharing detail portion for another sharing communication type, such as the e-mail sharing type 634 shown in FIG. 6, for sharing content under unit-based licensing in accordance with embodiments of this disclosure. In some embodiments, a sharing detail portion may include a sharing detail header portion 1010, a message header portion 1020, a message body portion 1030, or a combination thereof. In some embodiments, the sharing detail portion may be part of an external application, such as a third party e-mail application.

In some embodiments, the sharing detail portion may be included in the user interface 300 in response to input, such as user input. For example, the sharing detail portion may be included in the user interface 300 in response to receiving input selecting a sharing communication type, such as the e-mail sharing type 634 shown in FIG. 6.

The sharing detail header portion 1010 may include context information or controls, such as icons or links to user interface functions (not shown), which may include a cancel link, information describing the context, such as a name of a user of the sharing detail portion, a send link, or a combination thereof. Although the sharing detail header portion 1010 is described as including context information or controls, any information or controls may be included in the sharing detail header portion 1010.

The message header portion 1020 may include a primary recipient portion 1022, which may include descriptive information, such as “To:”, a name or description of one or more selected contacts, or a combination thereof. The message header portion 1020 may include a secondary recipient portion 1024, which may include descriptive information, such as “Cc/Bcc:”, a name or description of one or more selected contacts, or a combination thereof. The message header portion 1020 may include a subject portion 1026, which may include descriptive information, such as “Subject:”, text indicating that the customer account, or a user associated with the customer account, has sent a platform note, or a combination thereof.

The message body portion 1030 may include a message text portion 1032, a content representation portion 1034, such as album or track art for the content, or a combination thereof. The message text portion 1032 may include automatically generated text, such as text indicating that the customer account, or a user associated with the customer account, has sent a platform note, such as a “WEYV NOTE”. The automatically generated text may include instructions for accessing the platform note, which may include a link, such as a hyperlink, to access, download, or install an application, or a portion thereof.

FIG. 11 is a diagram of an example of a portion of a user interface 300 including a notifications portion for sharing content under unit-based licensing in accordance with embodiments of this disclosure. In some embodiments, a notifications portion may include a notifications header portion 1110, a notifications control portion 1120, one or more notification category portions 1130/1132/1134/1136/1138, one or more notification detail portions 1140/1142/1144/1146/1148, or a combination thereof.

In some embodiments, the notifications portion may be included in the user interface 300 in response to an event, such as receiving a notification, in response to input, such as user input selecting the notifications portion, or in response to a combination of an event and input. For example, a current user may share content with another user, and may access the notifications portion to review a status of sharing the content. In some embodiments, the status may indicate whether the recipient has accessed the content. In another example, a current user may receive a notification that another has shared content with the current user, and may access the notifications portion in response to receiving the notification.

The notifications header portion 1110 may include context information or controls, such as icons or links to user interface functions (not shown), which may include a back icon, information describing the context, such as “NOTIFICATIONS”, or a combination thereof. Although the notifications header portion 1110 is described as including context information or controls, any information or controls may be included in the notifications header portion 1110.

The notifications control portion 1120 may include information or controls for the notifications portion, such as instruction to swipe left to decline an invitation corresponding to a current notification, and instructions to swipe right to accept the invitation.

Each of the notification category portions 1130/1132/1134/1136/1138 may include information, such as a name or a description, of a notification category or type. For example, the first notification category portion 1130 may include information indicating that the notification category is associated with one or more requests or invitations to follow a user or be followed by a user, the second notification category portion 1132 may include information indicating that the notification category is associated with one or more platform notes or other platform communications, the third notification category portion 1134 may include information indicating that the notification category is associated with one or more collaborations or gifts, the fourth notification category portion 1136 may include information indicating that the notification category is associated with one or more information messages, such as news alerts, and the fifth notification category portion 1138 may include information indicating that the notification category is associated with one or more historical information elements. In some embodiments, the notification category portions 1130/1132/1134/1136/1138 may be visually differentiated for presentation or display by, for example, including a notification category portion specific background color. In FIG. 11, the notification category portions 1130/1132/1134/1136/1138 are shown with a stippled background to indicate a visual differentiation.

Each of the notification detail portions 1140/1142/1144/1146/1148 may include information, controls, or both, corresponding to elements within the corresponding notification category. For example, in FIG. 11, the notification detail portion 1142 within the second notification category portion 1132 may include a content representation portion 1150, a content information portion 1152, a content control portion 1156, or a combination thereof.

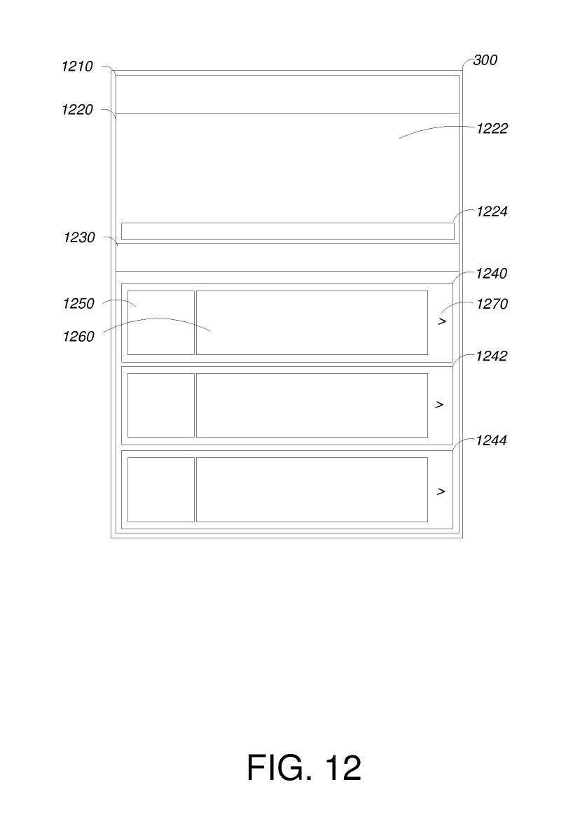

FIG. 12 is a diagram of an example of a portion of a user interface 300 including a recent activity portion for sharing content under unit-based licensing in accordance with embodiments of this disclosure. In some embodiments, a recent activity portion may include a recent activity header portion 1210, a recent activity context portion 1220, a recent activity control portion 1230, one or more recent activity detail portions 1240/1242/1244, or a combination thereof. In some embodiments, the recent activity portion may be included in the user interface 300 in response to input, such as user input.

The recent activity header portion 1210 may include context information or controls, such as icons or links to user interface functions (not shown), which may include a back icon, information describing the context, such a name of a current user, an edit control, or a combination thereof. Although the recent activity header portion 1210 is described as including context information or controls, any information or controls may be included in the recent activity header portion 1210.

The recent activity context portion 1220 may include context information for the recent activity portion. For example, the recent activity context portion 1220 may include an image 1222 representing a current user, and may include information or controls 1224 for the current user, such as a number of followers, and a number of users or accounts followed.

The recent activity control portion 1230 may include an indication of the current context, such as “Recent Activity”. In some embodiments, the recent activity control portion 1230 may include one or more controls or links to access other portions, such as a “Playlist” link to access playlists associated with the current user.

Each of the recent activity detail portions 1240/1242/1244 may respectively include information or controls related to a recent activity of the current user. For example, the first recent activity detail portion 1240 may represent the current user recently shared content with a specified user, and may include a representation portion 1250, which may include a representation of the content, such as album art, a description portion 1260, which may indicate the type of recent activity and may indicate the recency of the recent activity, and may include a recent activity control portion 1270, which may include a link to an activity detail portion for the recent activity, which may be similar to the activity detail portion shown in FIG. 13.

FIG. 13 is a diagram of an example of a portion of a user interface 300 including a shared content portion for sharing content under unit-based licensing in accordance with embodiments of this disclosure. In some embodiments, the shared content portion may include a shared content header portion 1310, a shared content detail portion 1320, or a combination thereof.

In some embodiments, the recent activity portion may be included in the user interface 300 in response to input, such as user input. For example, a current user may receive a shared content notification and may select the shared content notification 1340 as shown in FIG. 13.

The shared content header portion 1310 may include context information or controls, such as icons or links to user interface functions (not shown), which may include a back icon, information describing the context, such “WEYV NOTES”, or a combination thereof. Although the shared content header portion 1310 is described as including context information or controls, any information or controls may be included in the shared content header portion 1310.

In some embodiments, the shared content detail portion 1320 may include information, controls, or both for the shared content. In some embodiments, the shared content detail portion 1320 may include a shared content representation portion 1330, a shared content description portion 1340, a shared content control portion 1350, a shared content information portion 1360, or a combination thereof.

The shared content representation portion 1330 may include a representation of the shared content, such as album art, an image of the content author, or track art. In some embodiments, the representation may be an image identified by a sender of the shared content notification. In some embodiments, the representation may be automatically identified. For example, the representation may be a default shared content representation.

The shared content description portion 1340 may include information such as a album name, an author name, a track name or number, or any other information regarding the shared content. In some embodiments, the shared content description portion 1340 may include information, such as a name, identifying the sender of the shared content notification.

For example, the shared content may be a song and the shared content description portion 1340 may include a name of the song and a name of one or more artists of the song. In some embodiments, the name of the song may include a link to an album including the song.

In another example, the shared content may be an album and the shared content description portion 1340 may include a name of the album and a name of an artist of the album. In some embodiments, the name of the album may include a link to an album detail portion (not shown).

In another example, the shared content may be a playlist and the shared content description portion 1340 may include a name of the playlist and a name of a creator or owner of the playlist. In some embodiments, the name of the owner may include a link to a playlist detail portion (not shown).

In another example, the shared content may be an artist and the shared content description portion 1340 may include a name of the artist. In some embodiments, the name of the artist may include a link to an artist detailed portion (not shown).

The shared content control portion 1350 may include a control, such as a play control, for the shared content. Although not expressly indicated in FIG. 13, a control, such as the play control, may be actuated in response to input, such as user input, selecting the control, or selecting another portion of the user interface, such as the shared content representation portion 1330 or the background. Although not shown in FIG. 13, in some embodiments the content may be unavailable to access and the control may be may be visually differentiated or deemphasized to indicate that the content is unavailable. For example, the control may be displayed using an alternative visual style, such as a grayed out style.

The shared content information portion 1360 may include information regarding the shared content notification, such as a message identifying the content and indicating that the content has been shared.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method comprising:
receiving a content request from a device associated with a receiving user, the content request indicating content and a customer account, the content request generated in response to the device associated with the receiving user receiving a content communication from a sending user, the content communication indicating the content;
identifying a cardinality of assigned units for the content;
identifying a cardinality of available units for the customer account;
determining, by a processor, whether the cardinality of assigned units is within the cardinality of available units;
outputting a response indicating that the content request is granted on a condition that the cardinality of assigned units is within the cardinality of available units; and
outputting a response indicating that the content request is denied on a condition that the cardinality of assigned units exceeds the cardinality of available units.

2. The method of claim 1, wherein the content is a song, a portion of a song, a defined group of songs, a magazine, a magazine article, a newspaper, a newspaper article, a book, a chapter of a book, a video, or a portion of a video.

3. The method of claim 1, wherein the content communication is a platform communication.

4. The method of claim 1, wherein the content communication includes one or more of content information, or a content representation.

5. The method of claim 4, wherein the content information includes user generated content information, the content representation includes a user generated content representation, or the content information includes user generated content information and the content representation includes a user generated content representation.

6. The method of claim 1, wherein identifying the cardinality of available units includes identifying a cardinality of available units allocated to the customer account, the method further comprising:
on a condition that the cardinality of assigned units is within the cardinality of available units, charging the cardinality of available units allocated to the customer account based on the cardinality of assigned units for the content.

7. The method of claim 1, wherein identifying the cardinality of available units includes identifying a cardinality of available suballocated units associated with the content communication.

8. The method of claim 7, further comprising:
on a condition that the cardinality of assigned units is within the cardinality of available suballocated units, charging the cardinality of available suballocated units based on the cardinality of assigned units for the content.

9. The method of claim 7, wherein identifying the cardinality of available units includes identifying the cardinality of available suballocated units on a condition that a difference between a temporal location associated with the receiving user receiving the content communication and a temporal location associated with receiving the content request is within a defined threshold.

10. The method of claim 7, wherein identifying the cardinality of available units includes identifying the cardinality of available suballocated units on a condition that a cardinality of available uses associated with the content communication is greater than zero.

11. The method of claim 10, further comprising:
reducing the cardinality of available uses associated with the content communication by one in response to outputting the response indicating that the content request is granted.

12. The method of claim 1, further comprising:
receiving a second content request from a second device associated with a second receiving user, the second content request indicating the content and a second customer account, the second content request generated in response to the second device associated with the second receiving user receiving the content communication from the sending user, the content communication indicating the content;
identifying a second cardinality of available units allocated to the second customer account;
determining, by the processor, whether the cardinality of assigned units is within the second cardinality of available units;
outputting a second response indicating that the second content request is granted on a condition that the cardinality of assigned units is within the second cardinality of available units; and
outputting a response indicating that the second content request is denied on a condition that the cardinality of assigned units exceeds the second cardinality of available units.

13. A method comprising:
identifying a content object;
generating, by a processor of a device associated with a sending user in response to instructions stored on a non-transitory computer readable medium, a content communication indicating the content object, wherein the content object is associated with a cardinality of assigned units; and
transmitting the content communication to a device associated with a receiving user, wherein the receiving user is associated with a customer account, wherein a cardinality of available units is associated with the customer account, such that the content object is accessible by the device associated with the receiving user on a condition that the cardinality of assigned units is within the cardinality of available units.

14. The method of claim 13, wherein transmitting the content communication to the device associated with the receiving user includes transmitting the content communication to the device associated with the receiving user via a platform device such that the content object is inaccessible by the device associated with the receiving user on a condition that the cardinality of assigned units exceeds the cardinality of available units.

15. The method of claim 13, wherein the content object is a song, a portion of a song, a defined group of songs, a magazine, a magazine article, a newspaper, a newspaper article, a book, a chapter of a book, a video, or a portion of a video.

16. The method of claim 13, wherein transmitting the content communication to the device associated with the receiving user includes transmitting the content communication to a second device associated with a second receiving user associated with a second customer account, wherein a second cardinality of available units is associated with the second customer account, such that the content object is accessible by the second device associated with the second receiving user on a condition that the cardinality of assigned units is within the second cardinality of available units.

17. The method of claim 13, wherein generating the content communication includes:
in response to receiving input indicating user generated content information, including the user generated content information in the content communication;
in response to receiving input indicating a user generated content representation, including the user generated content representation in the content communication; or
in response to receiving input indicating user generated content information, including the user generated content information in the content communication, and in response to receiving input indicating a user generated content representation, including the user generated content representation in the content communication.

18. The method of claim 17, wherein transmitting the content communication includes transmitting the content communication such that a cardinality of available units for a customer account associated with the sending user is reduced by a cardinality of suballocated units in response to transmitting the content communication.

19. The method of claim 17, wherein transmitting the content communication includes transmitting the content communication such that a cardinality of available units for a customer account associated with the sending user is reduced by a cardinality of suballocated units in response to the device associated with the receiving user accessing the content.

20. A method comprising:
receiving, at a device associated with a receiving user, a content communication from a device associated with a sending user, the content communication indicating content;
in response to receiving the content communication, generating a content request indicating the content and a customer account associated with the receiving user;
transmitting the content request to a platform device;
on a condition that a cardinality of assigned units for the content is within a cardinality of available units for the customer account, receiving a response indicating that the content request is granted;
on a condition that the cardinality of assigned units for the content exceeds the cardinality of available units for the customer account, receiving a response indicating that the content request is denied; and
in response to receiving the response indicating that the content request is granted, accessing the content at the device associated with the receiving user.
